(19) United States
(12) Patent Application Publication
(10) Pub. No.: US 2025/0060478 A1
(43) Pub. Date: Feb. 20, 2025

(54) HIGH RESOLUTION WIDE SWATH SAR IMAGING

(71) Applicant: ICEYE OY, Espoo (FI)

(72) Inventors: Alan Thompson, Espoo (FI); Kenny James, Vancouver (CA)

(73) Assignee: ICEYE OY, Espoo (FI)

(21) Appl. No.: 18/722,132

(22) PCT Filed: Dec. 5, 2022
(86) PCT No.: PCT/EP2022/084406

§ 371 Date: Jun. 20, 2024

(30) Foreign Application Priority Data
Dec. 22, 2021 (GB) 2118749.7

(51) Int. Cl. G01S 13/90; G01S 13/02

(52) U.S. Cl. CPC G01S 13/9054; G01S 2013/0245

(57) ABSTRACT

A method of operating a Synthetic Aperture Radar ‘SAR’ to acquire image data of a swath comprising one or more subswath(s) is provided, wherein the SAR is carried on a platform moving along a flight direction and a radiated beam is directed towards the swath, the method comprising: electronically steering the beam in azimuth direction along one subswath for each burst; and mechanically steering the beam in a direction opposite to the flight direction during each burst. The method allows to obtain an improved swath to resolution ratio.

The present invention relates to Synthetic Aperture Radar (SAR) imaging. More particularly, the present invention is in the field of High Resolution Wide Swath (HRWS) SAR imaging.

### BACKGROUND

One of the main uses of Synthetic Aperture Radar (SAR) systems is to image and monitor the Earth's surface. In such uses, the SAR system are typically carried on air-borne or space-borne platforms. SAR systems are active radar systems in which pulses of radio waves are transmitted towards the area to be imaged, and the image is constructed by receiving and processing the echoes from the pulses as they are reflected or scattered back from the area of interest. SAR systems are fundamentally different from optical imaging systems in that they use different wavelength electromagnetic radiation and furthermore, they supply their own radiation. They have the advantage over optical systems of being able to acquire images day or night, and also through cloud cover.

SAR systems are well known in the art, and since the invention of SAR in the 1950s improvements continue to be made in the ability of SAR systems to image the Earth, for example with respect to the resolution that can be achieved and the size of the area that can be imaged. Generally, a longer antenna in a “real aperture” radar imaging system results in higher achievable resolution in the direction of travel of the platform carrying the antenna (known as the azimuth resolution). However, the length of antennas required to achieve good azimuth resolutions can make them prohibitive in terms of size and weight, particularly for spaceborne systems. SAR solves this problem by making use of the movement of the platform carrying the SAR system to create a “synthetic aperture” that can provide azimuth resolutions similar to a longer “real aperture” antenna but using a much shorter and smaller antenna. However, conventional single aperture SAR systems are still constrained by a fundamental trade-off between the azimuth resolution that can be achieved and the width of the “strip” that can be imaged, known as the swath width. Essentially, the trade-off is that achieving a finer azimuth resolution reduces the width of the swath that can be imaged, and a wider swath cannot be imaged without degrading the azimuth resolution.

This trade-off applies to well-known prior art SAR scanning modes such as Stripmap, ScanSAR (Scanning Synthetic Aperture Radar), and TOPS (Terrain Observation with Progressive Scans). Due to this limitation, a technique is desirable that allows a high azimuth resolution to be achieved while at the same time imaging a wider swath width.

In view of the limitations of the prior art, the technical problem underlying the present invention may be seen in the provision of a SAR imaging method to obtain an improved swath to resolution ratio.

The embodiments described below are not limited to implementations which solve any or all of the disadvantages of the known approaches described above.

### SUMMARY

This Summary is provided to introduce a selection of concepts in a simplified form that are further described below in the Detailed Description. This Summary is not intended to identify key features or essential features of the claimed subject matter, nor is it intended to be used to determine the scope of the claimed subject matter; variants and alternative features which facilitate the working of the invention and/or serve to achieve a substantially similar technical effect should be considered as falling into the scope of the invention disclosed herein.

In a first aspect there is provided a method of operating a Synthetic Aperture Radar ‘SAR’ to acquire image data of a swath comprising one or more subswath(s), wherein the SAR is carried on a platform moving along a flight direction and a radiated beam is directed towards the swath, the method comprises electronically steering the beam in the azimuth direction along one subswath for each burst, and mechanically steering the beam in a direction opposite to the flight direction during each burst.

In a second aspect, there is provided a satellite for operating in an orbit around the Earth comprising a Synthetic Aperture Radar ‘SAR’ to acquire image data of a swath comprising one or more subswath(s), wherein the satellite is configured to move along a flight direction and the SAR is configured to direct a radiated beam towards Earth, wherein the SAR is further configured to electronically steer the beam in azimuth direction along one subswath for each burst and mechanically steer the beam in a direction opposite to the flight direction during each burst

In a third aspect there is provided a ground station configured to control a satellite, optionally according to the second aspect, to carry out the method of the first aspect. The ground station may be configured to send a control signal to the satellite.

The methods described herein may be performed by software in machine readable form on a tangible storage medium e.g., in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards, RAM, flash memory, etc. and do not include propagated signals. The software can be suitable for execution on a parallel processor or a serial processor such that the method steps may be carried out in any suitable order, or simultaneously.

This application acknowledges that firmware and software can be valuable, separately tradable commodities. It is intended to encompass software and firmware that runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention. The method according to the first aspect may be set forth with the features as described in connection with the satellite according to the second aspect. The satellite according to the second aspect may be set forth with the feature described in connection with the method according to the first aspect.

### BRIEF DESCRIPTION OF THE DRAWINGS

Embodiments of the invention will be described, by way of example, with reference to the following drawings, in which:

FIG. 1 is a schematic perspective view of a satellite in orbit above Earth.

FIG. 2 is a schematic illustration of a satellite operating to acquire image data of a swath in ScanSAR mode.

FIG. 3 is a schematic illustration of a satellite operating to acquire image data of a swath during azimuth bursts while performing a mechanical backwards scan.

FIG. 4 is a schematic diagram illustrating (a) a direction of travel of the satellite, a direction of the mechanically steering, and a resultant effective ground speed of the beam of the satellite, and (b) an acquisition pattern.

FIG. 5 is a series of graphs illustrating superposition of (a) electronic steering in azimuth, (b) electronic steering in elevation, (c) mechanical steering in azimuth and (d) the acquisition pattern according to FIG. 4b.

FIG. 6 is a schematic diagram of components of a satellite.

FIG. 7 is a partial perspective view of a satellite.

FIG. 8 shows a plot of a signal and potential performance loss due to ambiguities in the azimuth direction.

FIG. 9 shows a plot of Range Ambiguities Ratios (RAR) against time for a single burst.

FIG. 10 illustrates an exemplary algorithm that can be used to determine parameters to be used for image acquisition.

Common reference numerals are used throughout the figures to indicate similar features.

### DETAILED DESCRIPTION

In a first aspect, the present disclosure provides a method of operating a Synthetic Aperture Radar ‘SAR’ to acquire image data of a swath comprising one or more subswath(s), wherein the SAR is carried on a platform moving along a flight direction and a radiated beam is directed towards the swath, the method comprising electronically steering the beam in the azimuth direction along one subswath for each burst, and mechanically steering the beam in a direction opposite to the flight direction during each burst.

First, the terminology used to describe SAR imaging will be explained:

To create a SAR image, successive pulses of radio waves are transmitted to illuminate a target scene, and the echo of each pulse is received and recorded. The pulses can be transmitted, and the echoes can be received using a single beamforming antenna. The transmitted pulses can be described as a radiated beam. In receive mode, the antenna receives the reflected and backscattered radiation from this radiated beam. As the SAR is carried on board a moving platform, such as a satellite, and therefore moves with respect to the target, the antenna location relative to the target changes with time and the frequency of received signals changes due to the Doppler effect. Signal processing of the successive recorded radar echoes allows the combination of recordings from multiple antenna positions thereby forming the synthetic antenna aperture to allow creation of higher resolution images.

An area on Earth instantaneously illuminated by the SAR is called a footprint. A swath is the strip of terrain that the footprint sweeps as the SAR moves over the Earth. A direction along the flight direction/direction of travel of the SAR is usually referred to as azimuth or “along track”. A direction transverse to the flight direction is usually referred to as range or “cross-track”. A direction opposite to the flight direction corresponds to the backward azimuth direction.

A swath comprises one or more subswaths. Each subswath may be different in range (or elevation). As an example, to obtain a large ground coverage, a swath may be composed of at least two and up to five subswaths. Alternatively, the swath may comprise up to ten subswaths, or up to twenty subswaths, or up to fifty subswaths. In each subswath, the image data may be blocked into bursts in the azimuth direction. In other words, each subswath may be divided in the azimuth direction into blocks, wherein image data of one block is collected during a burst. Each burst comprises a plurality of pulses. Typically, a burst may comprise from 20 to a few hundred pulses. Image data may be acquired using a burst-by-burst approach.

Beam steering refers to the pointing of the radiated antenna beam. For example, a beam can be steered electronically in SAR systems with phased array antennas by adjusting the phases of the RF signals going to and from the antenna elements. This changes the direction of the main lobe of radiation being transmitted and received from the phased-array antenna. Electronic beam steering has a high accuracy and can take place rapidly. In an example, electronic steering is used when the steering needs to happen quickly, and the angles required for steering are not large. This can be referred to as rapid small angle electronic steering.

Electronic beam steering can typically be performed in either the azimuth “along-track” direction, or in the elevation or “cross-track” direction or both.

An acquisition cycle comprises two or more azimuth bursts, wherein the beam is switched to point at different subswaths in the cross-track direction. A consecutive swath in length can be imaged by performing a plurality of acquisition cycles successively.

Mechanical beam steering refers to directing the beam of the SAR system by physically orienting the antenna or the platform carrying the antenna. Mechanical beam steering can allow for wide steering angles and thus can provide for wide ground coverage. Larger angles can be steered, but a steering angle rate is typically much slower than what is achievable with electronic steering. This is also referred to as large angle mechanical steering.

As alluded to in the background section, there is a trade-off between the azimuth resolution and the swath width. For Real Aperture Radar (RAR) systems, the azimuth resolution depends on the width of the radar beam (width of illumination) and the distance from the antenna to the target. The beam width in turn is typically inversely proportional to the antenna length (also known as the aperture), so longer antennas will in general result in a finer azimuth resolution. However, if the distance to the target is very great (e.g., if the radar system is carried on a space-borne platform), the azimuth resolution will be quite coarse unless the antenna is very long. Depending on the azimuth resolution required and the distance to the target, the antenna may need to be several kilometres long. This is clearly not practical for air-borne or space-borne systems, and in particular for space-borne systems.

SAR systems solve this by using the forward motion of the SAR platform and special processing of the echo data to create a very long synthetic antenna length (or aperture) using a much shorter real antenna. In the case of a SAR system with a focused beam, azimuth resolution Paz is independent of distance to the target, and is related to the length of the antenna L by an equation well-known to those skilled in the art of SAR, shown below as Equation 1:

$${ρ}_{az} \approx \frac{L}{2} \qquad ( Equation 1 )$$

There is no relative movement of the satellite in the range or cross-track direction, so the factors that drive range resolution are somewhat different from azimuth resolution. Whereas azimuth resolution depends on the length of the antenna, range resolution is dependent on transmitted pulse bandwidth.

Recall that SAR systems operate in a pulsed mode, sending out radar pulses in a transmit mode, and then switching off the transmit signal in order to receive the returning echoes. In some SAR systems, the transmit time is for example approximately 5% to 20% of the time required to complete one transmit/receive cycle. The pulses are sent out at a certain frequency, known as the Pulse Repetition Frequency (PRF). Due to the Nyquist sampling theorem, and to avoid aliasing, the PRF needs to be greater than the received Doppler Bandwidth, B_{D}, from all targets in the instantaneous field of view as shown in Equation 2:

$$PRF > {B}_{D} \qquad ( Equation 2 )$$

For classic strip map mode, the beam speed on the ground, V_{beam}, is essentially the same as the speed of the SAR platform over the ground, V_{g}, and the Doppler Bandwidth B_{D} can be expressed as a function of the ground speed of the SAR platform and the azimuth resolution ρ_{az}′ as shown below in Equation 3.

$${B}_{D} \approx {V}_{g} / {ρ}_{az} \qquad ( Equation 3 )$$

This gives rise to a fundamental inequality that limits the slant range swath width ΔRₛ as a function of azimuth resolution ρ_{az} and the speed of the SAR platform V_{g} over the ground, as shown in Inequality 4:

$$Δ {R}_{s} < ( \frac{c}{2} ) PRI < ( \frac{c}{2} ) ( \frac{1}{{B}_{D}} ) \approx ( \frac{c}{2} ) {ρ}_{az} / {V}_{g} \qquad ( Inequality 4 )$$

In Inequality 4, c is the speed of light and PRI is the Pulse Repetition Interval as given by the inverse of the Pulse Repetition Frequency (PRF). This inequality describes the fundamental trade-off between slant range swath width and azimuth resolution: finer azimuth resolution requires a higher pulse repetition frequency, and hence a smaller pulse repetition interval, thereby resulting in a narrower slant range swath width.

Note the slant range swath width ΔRₛ is the difference between the distance from the antenna to the far edge of the swath and the distance from the antenna to the near edge of the swath, not the actual width of the swath along the ground. The ground swath width is also dependent on the angle at which the swath is being imaged, and the actual value can be calculated from the slant range swath width using basic trigonometry and techniques well known in the art. Regardless, larger slant range swath widths result in larger ground swath widths for a given slant angle.

To provide an example of how the slant range swath width is calculated based on azimuth resolution, consider a satellite carrying a single-aperture SAR system operating in low-earth orbit at approximately 550 km above the Earth's surface. At a distance of 550 km above the Earth's surface, the satellite would have a ground speed of approximately about 7 km/s, in an earth-centred rotating coordinate system. Inserting 7 km/s for v_{g} along with the speed of light of approximately 300,000 km/s for c into Inequality 4, the slant range swath width is as shown in Inequality 5:

$$Δ {R}_{s} < 21 \frac{km}{m} {ρ}_{az} \qquad ( Inequality 5 )$$

Inequality 5 can then be used to calculate the maximum slant range swath width achievable for a given resolution for this satellite. If for example the desired azimuth resolution is 1.5 m, the maximum slant range swath width that this can be achieved at would be approximately 32 km. In an example with incidence angles of between approximately 45° and 47.7° and a slant range swath width of approximately 32 km, the ground swath width would be approximately 44 km.

In an example according to the current disclosure, a satellite carrying a single-aperture SAR system and a method of operating such a satellite is described such that a higher slant range swath width to azimuth resolution can be achieved without requiring multiple apertures. This is achieved by combining mechanical steering in the azimuth direction with electronic steering. According to this example, the beam is mechanically steered in a direction opposite to the flight direction during each azimuth burst. This is also referred to as a (superimposed) mechanical backwards scan.

For the classic SAR strip map mode and ScanSAR mode, V_{beam} is essentially the same as the speed of the SAR platform over the ground, as shown below in equation 6:

$${V}_{beam} = {V}_{g} \qquad ( Equation 6 )$$

Note that in the example of a SAR system carried by a satellite, the speed of the satellite over the ground in an earth rotating coordinate system can be different than the inertial speed of the satellite in its orbital path due to the rotation of the earth and the satellite travelling in an orbit with a larger semi-major axis than the Earth radius. In airborne systems this difference is negligible for practical purposes.

In an example according to the current disclosure, mechanically steering a satellite in a direction opposite to the flight direction superimposes a speed in the reverse direction on the satellite speed over the ground, such that the effective speed of the beam over the ground V_{beam} is less than V_{g}, as shown in Inequality 7 below.

$${V}_{beam} < {V}_{g} \qquad ( Inequality 7 )$$

In this example, V_{g} in Inequality 4 is no longer equal to V_{beam} and mechanically steering the beam in a direction opposite to the flight direction effectively decouples the beam ground speed from the satellite ground speed.

By decoupling the beam ground speed from the satellite ground speed, Inequality 4 no longer applies, and it becomes possible to achieve higher swath width to resolution ratios than Inequality 4 would otherwise permit. In an example, the beam ground speed V_{beam} is selectable via mechanical steering and can range from the V_{g} all the way down to zero. A faster backwards mechanical slew rate can even result in a negative V_{beam} but the overall dwell time on a particular spot would be reduced.

Acquiring image data of one subswath may comprise acquiring image data in one or more bursts. Two successive bursts may illuminate a same section, overlapping sections, different adjacent sections, or different sections spaced from one another of the one subswath. Thus, a single continuous strip corresponding to one subswath may be imaged. Acquiring image data of two or more subswaths may comprise acquiring image data in two or more bursts, wherein at least two bursts illuminate different subswaths.

In an example, acquiring image data within a subswath can comprise electronic steering during each azimuth burst. The beam can be electronically steered in the azimuth direction from backward to forward (forward azimuth burst). This can provide for better radiometric uniformity throughout the swath compared to classic ScanSAR. In an example, the electronic steering within each burst can also be performed in the azimuth direction from forwards to backwards (backwards azimuth burst).

Mechanically steering the beam may be performed by rotating the SAR with respect to the platform and/or moving or slewing the platform including the SAR. Alternatively, a rotating reflector could be used to steer the SAR. To direct the beam to a particular target, the platform, such as a satellite, may carry out the rotation itself, when it is small enough for mechanical steering and the antenna is rigidly attached to the platform. The beam may be mechanically steered over a range of viewing angles between at least −10° and +10°, −23° and +23°, −30° and +30°, −45° and +45°, or −60° and +60°.

Mechanically steering the beam can reduce an effective ground speed of the beam over the ground. Any scan speed of the mechanical backwards scan that is smaller than the satellite ground speed will reduce the effective ground speed of the beam on the ground. The effective ground speed can be reduced to zero when the speed of the mechanical backwards scan equals the satellite ground speed. In this embodiment, a spotlight mode is utilized in which the beam is steered towards a fixed point to illuminate/dwell on a particular region. The long illumination duration leads to an increased synthetic aperture length and thus a better resolution.

A steering angle rate for mechanically steering the beam may be lower than a steering angle rate for electronically steering the beam. In an example, the mechanical steering angle rate is lower than the electronic steering angle rate at least by a factor of 2, or by a factor of 3. A good controllability of the electronic steering allows to choose a steering angle rate for an azimuth burst. For example, during one azimuth burst, the beam may be electronically steered with a steering angle rate of 1°/s or more to achieve a high illumination time. Alternatively, the beam may be electronically steered with a steering angle rate of 2°/s or more during each burst while performing two consecutive bursts on the same target to increase the number of viewing angles. This can help to reduce speckle in an image by averaging the value of each pixel over two or more “looks”, or to improve the resolution by increasing the target illumination time. Between azimuth bursts, the beam may be electronically steered at a much faster rate such as 100°/s or higher. Typically, mechanical steering proceeds at a much slower and more continuous rate than electronic steering due to the inertia associated with mechanical systems. The mechanical backwards scan may be performed for example at 1°/s or less, 2°/s or less, or 5°/s or less

In an example, a steering angle range for mechanically steering the beam may be higher than a steering angle range for electronically steering the beam, optionally at least by a factor of 5, at least by a factor of 10 or at least by a factor of 30. This implementation allows that image acquisition may already begin while the target is still outside the range accessible with electronic steering and/or continue while the target is no longer inside the range accessible with electronic steering. Electronic steering in azimuth is typically performed over a range of ±1°, ±1.5°, or ±2° wherein mechanical steering can be practically performed over a range of up to ±45°. The range for the mechanical scan can be chosen depending on the desired image size/swath length and desired resolution. The limits on available angle ranges for electronic steering vary from one physical apparatus to another but in an example the limits might be set at up to ±25° in elevation or higher, and ±2° in azimuth or higher.

To increase the total swath width and therefore the coverage area for the image, the beam may be electronically steered in elevation between two bursts. Two dimensional electronic steering (in elevation and azimuth) allows multiple subswaths to be imaged by the same SAR beam. Within each subswath, an imaged area can be scanned with one burst, or with two or more bursts of shorter duration. This can be achieved by electronically steering the beam in azimuth from forwards to backwards between bursts, so that the two or more bursts may each be performed as a forward azimuth burst. Thus, the two bursts are performed with the same azimuth antenna pattern covering the same area. Between bursts, the beam can be steered very rapidly using small angle electronic steering in azimuth, elevation, or both, on a very fast virtually instantaneous timescale.

If a wider swath is required, the beam may be successively steered in elevation during one acquisition cycle comprising a plurality of bursts, wherein each burst illuminates a different subswath. During one acquisition cycle, the pattern is not fixed to one subswath but successively steered to different elevation angles corresponding to two or multiple subswaths. Each subswath is illuminated during one or more bursts

Two or more acquisition cycles may be performed, wherein each first burst of each acquisition cycle illuminates the same subswath. The acquisition cycles may be repeated at different azimuth positions. The steering in elevation is cyclically repeated to allow the imaging of two or multiple continuous subswaths. When the last subswath is illuminated, the antenna is electronically steered back to the first subswath, so that no gaps are left between bursts of the same subswath. This acquisition pattern allows to obtain wide-swath SAR images. The electronic steering performed in this acquisition pattern may correspond to that of the Terrain Observation by Progressive Scans ‘TOPS’ imaging mode. With the TOPS acquisition pattern, better radiometric uniformity can be achieved compared to regular SCANSAR, that only uses electronic steering in elevation. When electronic steering in both azimuth and elevation is combined with mechanical steering, high resolution and wide swath imaging becomes possible, particularly with small and agile satellites. In an example, a swath of at least 100 km×100 km may be imaged with a resolution of as fine as 5 m by a small agile satellite, or micro-satellite, that only has a mass of about 150 kg.

Mechanically steering the beam in the direction opposite to the flight direction may be performed continuously during the two or more acquisition cycles. Thus, a slow backwards azimuth scan is superimposed on the quick electronic steering in elevation and azimuth to allow imaging of two or multiple continuous subswaths. The mechanical steering throughout the acquisition from forward to backward may be at a constant rotation rate, or at a varying rate such as that required to maintain the effective ground speed constant. When the beam is mechanically steered from forward to backward, the Doppler frequency shift changes from >0 to 0 to <0. Due to the superimposed mechanical scan, the electronic scanning is substantially not perpendicular to the flight direction all times. Instead, the look direction during the acquisition can for example start out substantially non-perpendicular forward looking, transition through substantially perpendicular side-looking, and finish up substantially non-perpendicular backwards looking. Using a single continuous mechanical backwards scan allows an increased acquisition time because settling times induced due to mechanical antenna positioning such as moving or slewing/settling a satellite or an antenna on the satellite are reduced.

Parameters to be used for image acquisition may be determined by: selecting an image size, selecting a resolution, picking a maximum electronic steering angle, calculating a burst duration, selecting a beam speed, and deriving an image acquisition time.

In a second aspect, the present disclosure provides a satellite for operating in an orbit around the Earth comprising a Synthetic Aperture Radar ‘SAR’ to acquire image data of a swath comprising one or more subswath(s), wherein the satellite is configured to move along a flight direction and the SAR is configured to direct a radiated beam towards Earth, wherein the SAR is further configured to electronically steer the beam in azimuth direction along one subswath for each burst and mechanically steer the beam in a direction opposite to the flight direction during each burst.

The satellite may comprise an Attitude Determination Control System ‘ADCS’ including one or more reaction wheels configured to control the mechanical steering of the beam by rotating the satellite including the SAR. In an example, satellites can use three or more reaction wheels so that they can be rotated around all three axes. The ADCS may be used to control the orientation of the satellite and may be implemented in a number of ways.

The satellite may be configured to mechanically steer the beam by slewing in the azimuth direction at up to 1°/second. The satellite may have a total mass of less than 1000 kg, less than 500 kg, less than 250 kg, or less than 100 kg. A satellite having a low mass has a much lower moment of inertia than traditional larger SAR satellites. Larger satellites require greater expenditure of energy and time to accelerate to rotate at a given slew rate due to their higher moment of inertia, and also to slow them down again. The power requirements to slew the satellite at a given rate are much less onerous for smaller satellite systems with lower moments of inertia, which is an advantage because of the limited power available to satellites in space.

The SAR may comprise a small single aperture radar and/or a phased array allowing electronic beam steering in two dimensions. The SAR may comprise a single aperture phased array radar. With a single aperture radar the pulses are transmitted and the echoes are received using a single beam-forming antenna. Due to the limited available space for sensor payloads, single aperture radars, particularly smaller ones, are desirable for the design of compact, high-resolution SAR systems on board of (unmanned) moving platforms, such as a satellite. According to the present disclosure, a fine azimuth resolution and a wide swath can be obtained simultaneously using a small single aperture radar which is not normally possible due to the fundamental limits according to Inequality 4. Accordingly, a single aperture radar may overcome the limitations that could previously only be overcome through multi-aperture approaches at increased costs for the antenna. A phased array antenna with antenna elements spatially distributed over two dimensions perpendicular to the radar-range dimension may allow two-dimensional beam steering in azimuth and elevation.

The physical apparatus can be designed to provide for different electronic steering ranges. In an example, the total range possible for electronically steering a phased array antenna is dependent on the spacing between the elements of the antenna in azimuth and elevation. The closer the spacing of the elements, the wider the range that can be achieved. The antenna elements in a phase array antenna can be arranged in two-dimensional a grid pattern such that the spacing in one direction can be quite different from the spacing in the other direction. As such, the angle range in azimuth can be quite different from the angle range in elevation, even though the electronic steering is achieved in a similar manner in both directions. In an example, a phased array antenna has 20 antenna elements spread out over 3.2 m for directing the beam in the azimuth direction, providing for an antenna element spacing of approximately 160 cm an electronic steering range of about ±1° in azimuth. In the same example, the same phased array antenna may have 16 antenna elements spread out over 40 cm for directing the beam in the elevation direction, providing for an antenna element spacing of approximately 2.5 cm. The closer spacing allows for a much wider electronic steering range in the elevation direction of ±25°. Higher angle ranges can be achieved in the azimuth direction by adding more antenna elements and spacing them closer together, but this can lead to additional complexity, weight, cost, and other trade-offs. In a third aspect, the present disclosure provides a ground station configured to control a satellite, optionally according to the second aspect, to carry out the method of the first aspect. The ground station may be configured to send a control signal to the satellite.

Embodiments of the present invention are described below by way of example only. These examples represent the best mode of putting the invention into practice that are currently known to the Applicant although they are not the only ways in which this could be achieved.

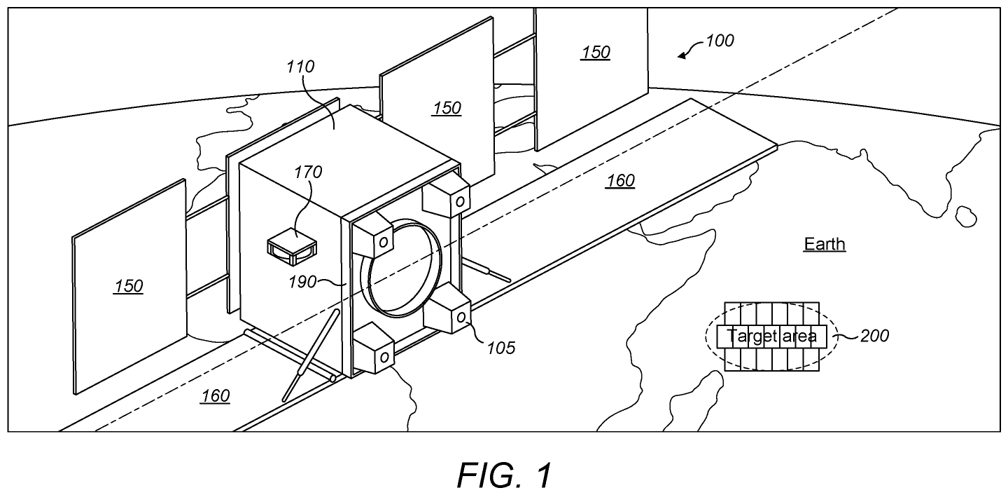

FIG. 1 is a perspective view of a satellite 100 in orbit over Earth as an example of a platform which may be used in the methods and systems for earth observation described here. A target area on Earth to be imaged is indicated at 200. The satellite 100 comprises a body 110, solar panels 150 and “wings” 160. One or more antennas may be mounted on the satellite wings. Each antenna may comprise a phased array antenna, in other words each antenna may comprise multiple antenna elements which may be controlled to electronically steer the direction of the antenna beam, to control the direction and shape of a transmitted pulse and/or to control the direction and area from which echoes may be received.

The satellite 100 may be configured for mechanically steering the antenna, and hence the beam when in transmit and/or receive mode in addition to the electronic steering. In this example mechanical steering is achieved by steering the whole satellite 100. This may be achieved using the satellite attitude determination and control system ADCS, which may be provided with one or more reaction wheels, one of which is indicated at 170. The ADCS may be used to mechanically steer the satellite to maintain target area 200 within the radar apertures, in other words in sight of the satellite, for a longer period than the target area 200 would be visible without mechanical steering as the satellite 100 travels in its orbit.

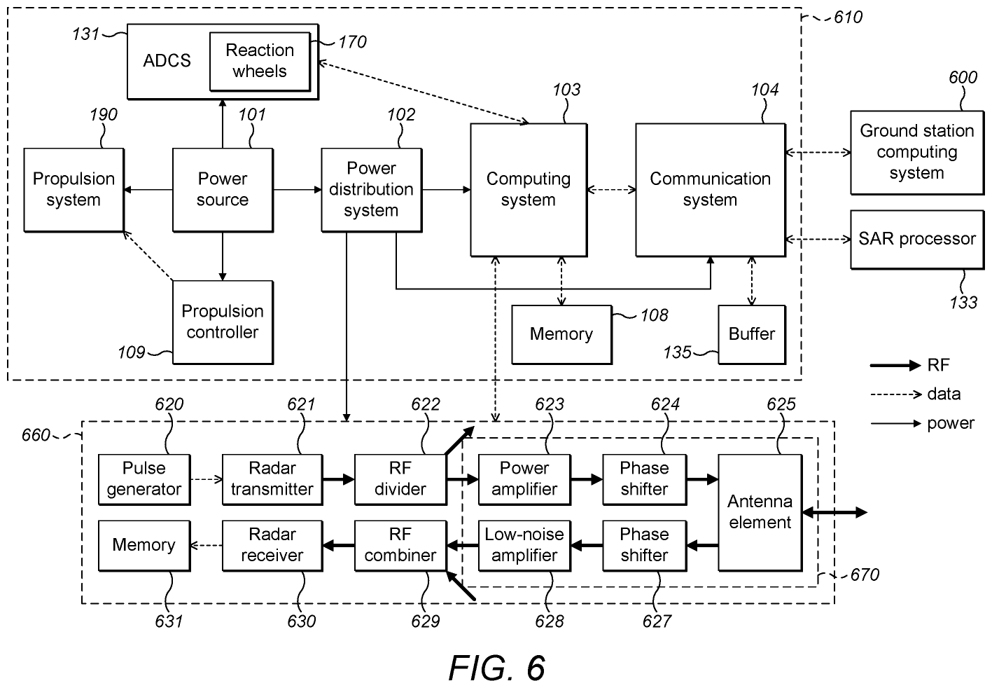

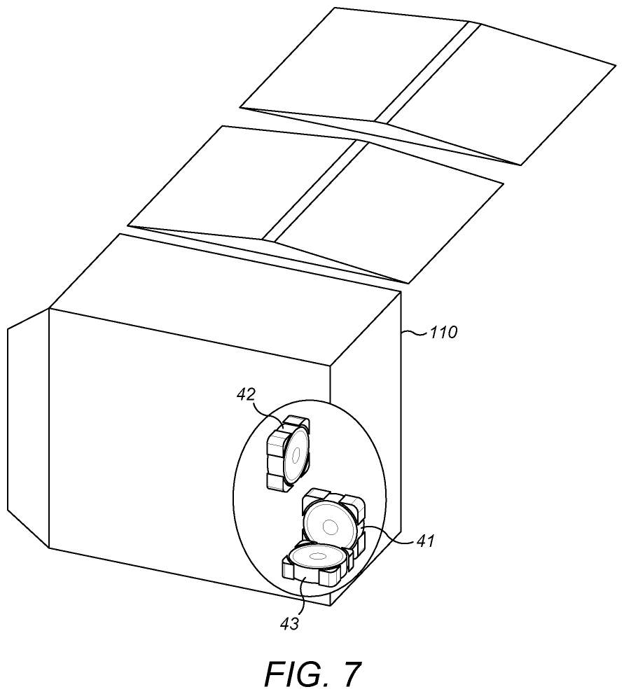

Further details of the satellite of FIG. 1 are described with reference to FIGS. 6 and 7.

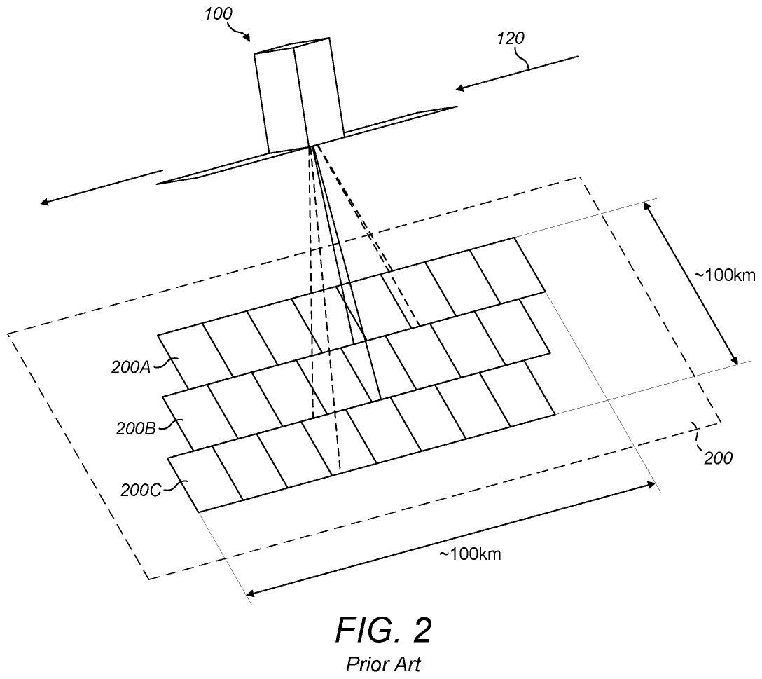

FIG. 2 is a schematic illustration of a satellite operating in ScanSAR imaging mode according to the prior art. The satellite 100 is a well-known side-looking configuration in which it sends and receives signals from a target area 200 to the side of the satellite 100 rather than directly below it. In this side-looking configuration, the bottom of the wings 160 (where the antenna elements are located) are pointed towards the area being imaged. The satellite 100 travels in the flight direction 120. The target area 200 has a width, also known in the art as the swath. In this example, the swath comprises subswaths 200A, 200B, 200C. For each radar pulse transmitted from the satellite 100 signal data in the form of echoes may be received from different points across the swath 200, at different frequencies due to the Doppler effect which is central to SAR.

The satellite 100 is shown to be travelling from right to left as indicated by the arrow with respect to Earth in its orbit. In ScanSAR mode, an area from which data is to be collected, for example the 100 km×100 km area indicated in FIG. 2, is divided into a suitable number of subswaths, for example the three subswaths 200A, 200B, 200C, wherein each subswath is divided in azimuth into what is referred to here as “blocks”. Accordingly, in each subswath the received data are blocked into bursts of radar echoes in the azimuth direction. In the example of FIG. 2, the blocks form an offset pattern. A wide swath 200 composed of several subswaths 200A, 200B, 200C is imaged by means of alternately illuminating each subswath. The radar antenna beam sweeps through different elevation subswaths 200A, 200B, 200C to image a wide swath 200. The available illumination time is shared between a number of bursts covering different regions or “blocks” on the ground, thereby trading off azimuth resolution for wider coverage. To switch between the different subswaths 200A, 200B, 200C electronic steering in elevation is performed very quickly.

In classic ScanSAR as depicted in FIG. 2, a beam speed over the ground is the same as the satellite ground speed. Thus during each burst, no electronic beam steering is performed and the beam slides along at the satellite ground speed. Accordingly, the azimuth resolution is impaired, because the swath per resolution constraint according to Equation 4 applies.

In some of the methods and systems to be described in more detail in the following, mechanical beam steering in a direction opposite to the flight direction is performed while during each burst electronic beam steering in azimuth is also performed for increased radiometric uniformity.

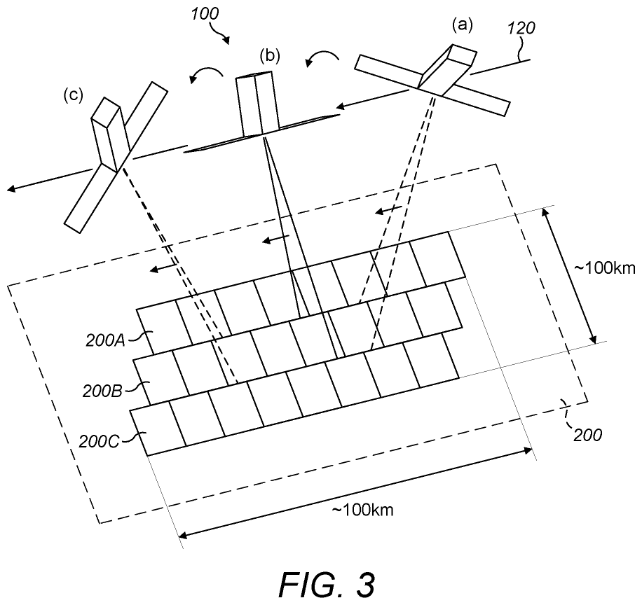

FIG. 3 illustrates schematically how image data of a swath 200 is acquired when operating in burst mode while performing a mechanical backwards scan. The mechanical steering is illustrated in exaggerated form in FIG. 3, where the satellite 100 is shown to have a different orientation at each of the three positions (a), (b) and (c) along its path. Between each position along the flight direction 120 the satellite 100 has rotated as indicated by the arrows to point further backwards in the azimuth direction. The rotation is opposite to the flight direction 120. In a first position (a) the satellite 100 looks ahead relative to the direction of travel 120, in a second position (b) the satellite beam is perpendicular to the satellite's direction of travel, and in a third position (c) the satellite 100 looks backwards relative to the direction of travel 120. Accordingly, the satellite 100 performs a mechanical backwards scan. Due to the superimposed mechanical scan, the look direction is substantially not perpendicular to the flight direction with the only exception being position (b). This implementation allows that image acquisition may already begin before position (a) while the target 200 is still outside the range accessible with electronic steering and/or continue after position (c) while the target is no longer inside the range accessible with electronic steering.

In addition to the mechanical backwards scan, the beam is electronically steered in azimuth during each burst, which is indicated in FIG. 3 by the arrows between the beams in each position. The electronic steering in azimuth is performed in the forward direction as indicated by the arrows. In another example, electronic steering in azimuth can be performed in the backwards direction. Due to the azimuth beam steering every point is illuminated by a full azimuth beam. Compared to ScanSAR shown in FIG. 2, the azimuth rotation achieved by electronic steering throughout the acquisition achieves the same swath coverage but allows better radiometric uniformity to be achieved.

The beam speed over ground during the acquisition corresponds to a sum of the mechanical steering and electronic steering within one burst, thereby decoupling the beam speed over ground from satellite ground speed. In other words, the beam ground speed depends on the scan speed during the azimuth burst and the speed of the mechanical backwards scan. Accordingly, the beam ground speed is selectable via mechanical steering. Mechanically steering the beam in a direction opposite to the flight direction 102 reduces an effective ground speed of the beam on Earth, thereby allowing greater illumination and hence better resolution. The effects of slowing down the beam ground speed are a longer burst duration and a longer acquisition time, which leads to a finer resolution. Therefore, the azimuth resolution is not impaired, because the swath per resolution constraint according to Inequality 4 does not apply.

In addition to the mechanical backwards scan and the electronic steering in azimuth during each burst, the beam is successively steered in elevation during a plurality of acquisition cycles. In the example in FIG. 3, the swath 200 comprises three subswaths 200A, 200B, 200C, wherein each subswath comprises a plurality of blocks. At the end of a burst in e.g., a first subswath 200A, the look angle is changed to illuminate a second subswath 200B pointing again backward. When a third/last subswath is imaged, the beam points back to the first subswath, so that no gaps are left between bursts of the same subswath. The beam steering between bursts is achieved by rapid small angle electronic steering.

The swath 200 depicted in FIG. 3 being a 100 km×100 km area can be imaged with a 5 m resolution. The satellite travels along the flight direction with a speed of 7.5 km/s, wherein the mechanical steering superimposes a speed of −3.75 km/s on the actual ground speed of the satellite, resulting in an effective ground speed of 3.25 km/s. The total mechanical steering angle in this example is 35°.

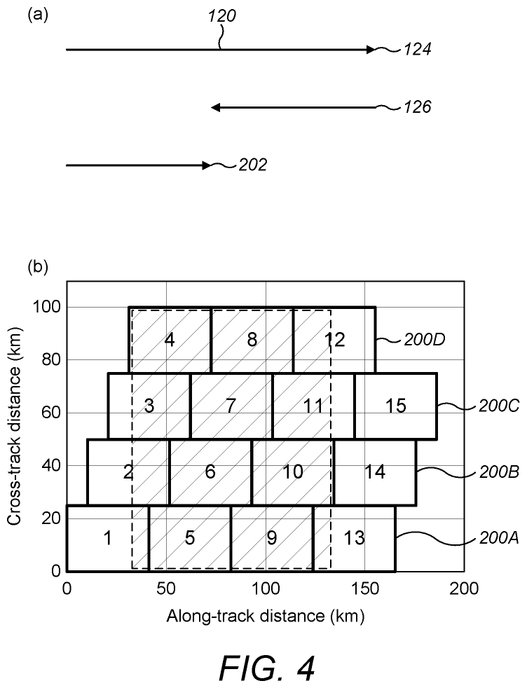

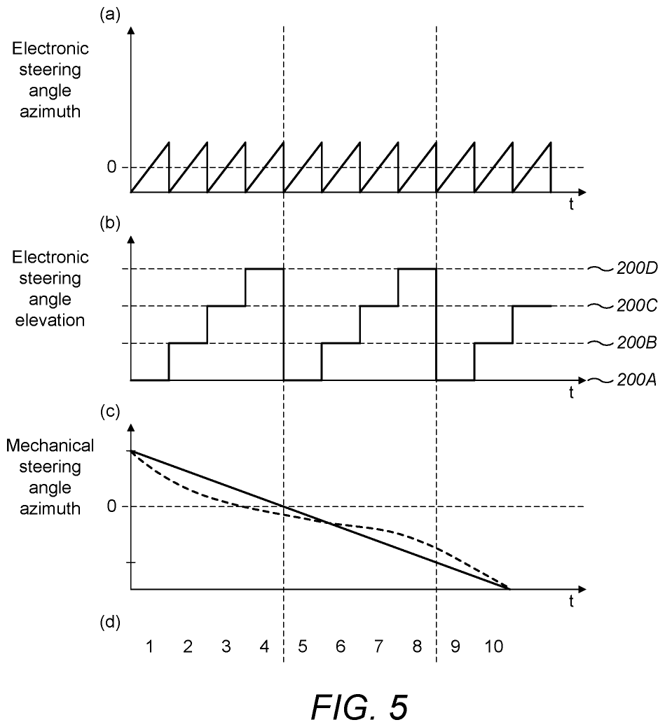

Further examples of superimposing electronic and mechanical steering will now be described with reference to FIGS. 4 and 5.

FIG. 4a illustrates how the beam ground speed is selectable via mechanical steering. The top arrow 124 in FIG. 4a represents the speed of the satellite which is directed along the flight direction 120. The arrow 126 represents the direction of the mechanical steering which is directed opposite to the flight direction 120 and smaller than the speed of the satellite 124. Arrow 202 depicts the resulting effective ground speed of the beam which is directed along the flight direction 120. Accordingly, by using a superimposed mechanical backwards scan, the effective ground speed of the beam is reduced and decoupled from the satellite ground speed. The effective ground speed of the beam 202 is selectable via the mechanical steering 206. Not shown in FIG. 4a is the scan speed induced during the electronic steering within each azimuth burst, which may be directed along or opposite to the flight direction. For the sake of completeness, steering in elevation is not shown because it does not affect the beam ground speed.

FIG. 4b illustrates the offset pattern of the burst images after processing the raw synthetic aperture radar data. FIG. 4b depicts an area on the ground divided into smaller areas, or blocks, in an offset pattern as it might be for operation of SAR in ScanSAR or TOPS mode. Thus, as previously described, the SAR beam may be steered electronically to collect data from blocks 1-15 in turn in numerical order and in the flight direction 120 from left to right (see FIG. 4a). The cross-hatched rectangle within the dashed line in FIG. 4b corresponds to an area or swath to be imaged of 100 km×100 km. In comparison to FIG. 3, the swatch comprises four subswaths 200A, 200B, 200C, 200D.

The acquisition pattern depicted in FIG. 4b will be explained with reference to the time diagrams of FIG. 5. The blocks labelled 1-10 in FIG. 4b correspond to the bursts 1-10 shown in FIG. 5d. Accordingly, each block is imaged in one (single) burst. Instead of imaging each block in a single burst, more than one burst could be performed for each block to increase the number of look angles for each block, but at the cost of less fine resolution. When each block is imaged in one burst, an acquisition cycle comprises four successive bursts that correspond to blocks in four adjacent subswaths 200A, 200B, 200C, 200D that are different in elevation. Accordingly, to image the swath, in a first acquisition cycle blocks 1-4 are imaged, in a second successive acquisition cycle blocks 5-8 are imaged and so on.

To do this, the beam is electronically steered in forward in azimuth periodically, as shown in FIG. 5a, where the beam angle in azimuth is steered from a negative angle through zero to an equal positive angle over a burst period. At the end of the burst period, the beam is quickly steered back to the negative angle. This is indicated as a substantially vertical line in FIG. 5a as it can take place within microseconds. For successive bursts, this is repeated over the same range of angles.

To switch between subswaths, the beam is electronically steered in elevation periodically, as shown in FIG. 5b. During each burst the beam points to a constant elevation angle for each burst period corresponding to the respective subswath 200A, 200B, 200C, 200D, which is indicated by horizontal lines in FIG. 5b. At the end of the burst period, the beam is quickly steered (stepwise) in elevation and in the cross-track direction to the next subswath. At the end of each acquisition cycle, the beam is quickly steered back to the first subswath. This is indicated as substantially vertical lines in FIG. 5b as it takes place within microseconds.

Superimposed on the periodic electronic steering in azimuth and elevation is mechanical rearward steering in azimuth over a larger range of angles and for a longer period of time as shown in FIG. 5c. FIG. 5c shows two simplified examples of the mechanical steering for the purpose of illustration. The solid line shown in FIG. 5c corresponds to a constant steering angle rate for the mechanical steering, such as a constant rotation of the satellite. The dashed line in FIG. 5c corresponds to a non-linear steering angle rate for the mechanical steering that could be used to maintain the effective ground speed constant. The non-linear steering angle rate provides higher rates at the start and at the end (when the steering angle is largest) and smaller rates when the steering angle is around zero (when the look direction is perpendicular to the flight direction). The mechanical rearward steering in azimuth may also correspond to a combination of a linear and non-linear steering angle rate.

The beam angle in azimuth may be mechanically steered from a positive angle through zero to an equal negative angle over the acquisition period (only the beginning of the acquisition period is depicted in FIG. 5). With regard to the exemplary rotation shown in FIG. 3, a positive angle corresponds to the first (forward looking) position (a), zero corresponds to the second (perpendicular to the direction of flight) position (b) and a negative angle corresponds to the third (back looking) position (c). The mechanical rearward steering may also be performed over an asymmetric steering angle range, such as for example only for steering angles<0 or >0.

As shown in FIG. 5, in particular when comparing FIGS. 5a and 5c, the steering angle rate for mechanically steering the beam is lower than the steering angle rate for electronically steering the beam. The good controllability of the electronic steering rate allows to choose a specific electronic scan rate to increase the illumination time for each block. Further, the steering angle range for mechanically steering the beam is much higher than a steering angle range for electronically steering the beam. A typical steering angle range is approximately ±1° in azimuth and up to ±25° in elevation for electronically steering the beam, while a mechanical steering angle range can be up to ±45°, or up to ±60°. Although it may theoretically be possible to achieve larger azimuth steering angles with electronic beam steering, it would require a more complex, larger, and more expensive antenna. By combining rapid small angle electronic steering and large angle mechanical steering an improved swath width to resolution ratio can be achieved not possible with other known single aperture radar imaging techniques.

In a practical implementation, a total acquisition time of the area indicated by the rectangle in FIG. 4b (comprising three or four subswaths) is approximately 40 seconds and a resolution of 5 m can be achieved. In this example, each burst requires approximately 2.5-3 s. For the sake of comparison, it is mentioned that a total acquisition time of the same size area in ScanSAR mode (as shown in FIG. 2) is approximately 15 seconds and a resolution of 15 m can be achieved. The longer acquisition time according to the current invention is made possible by the mechanical backwards scan that is superimposed upon the satellite speed over the ground and results in a slower effective ground speed of the beam. In an alternative example, an area of 60 km×60 km comprising two subswaths may be imaged with a resolution of 3 m and a total acquisition time of 35 sec.

As noted elsewhere, the methods described here are particularly but not exclusively suited to implementation in connection with a SAR carried on a satellite. The SAR could for example be carried on other platforms such as on an airplane. A satellite suitable for use in implementing the invention will now be described with reference to FIGS. 1, 6 and 7.

FIG. 6 is a schematic diagram representation of the components of a satellite, for example a micro satellite, according to some embodiments of the invention. Solid arrows between components are used to indicate power connections, heavier solid arrows are used to indicate RF signal connections, and dashed lines are used to indicate data connections.

Some components are part of the satellite “bus” 610, indicated by a rectangle in FIG. 6, and some may be part of the “payload” 660, indicated by a rectangle in FIG. 6. Other components are part of an antenna module 670, also indicated by a rectangle in FIG. 6. The satellite components shown in FIG. 6 comprise a power source 101 and a power distribution system 102. The power source 101 and power distribution system 102 supply power to a propulsion system 190, propulsion controller 109, attitude determination and control system “ADCS” 131, computing system 103, buffer 135, and a communication system 104. The power source 101 and the power distribution system 102 also supplies power to components within the payload 660, such as the pulse generator 620 and the power amplifier 623. The buffer 135, although shown as a separate item, may be comprised in the computing system 103. The propulsion controller 109 is shown here as a separate item but in practice it may form part of the computing system 103. The propulsion controller may be controlled either through the use of control software implemented in one or more processors comprised in the propulsion controller 109 or in response to received instructions, for example from the computing system 103. Where the instructions are transmitted from the computing system 103, the computing system may be considered to comprise a propulsion controller. One of the functions of the propulsion controller 109 may be to output control signals to ion sources and electron sources of thrusters in the propulsion system 190.

The satellite bus 610 may generally be located in the body of the satellite 110. Power distribution system 102 may comprise control logic as is known in the art. The communication system 104 may include one or more communication antennas, for example located on the satellite body. Alternatively, the communication system 104 may send and receive signals via one or more communication antennas located on a wing of the satellite

In the case of an earth observation satellite, the satellite payload 660 may include one or more radar antenna arrays, which may be located at one or more wings 160 of the satellite. FIG. 6 shows a single antenna element 625 which may be part of a phased array antenna used for SAR imaging. Antenna element 625 transmits and receives signals 626. Antenna element 625 is shown to have an associated power amplifier 623 and phase shifter 624 for transmitting the radar signal, and an associated low-noise amplifier 628 and phase shifter 627 for receiving the return signal. Together these form an antenna module 670. The phased array antenna can comprise multiple antenna modules 670. In an example, a satellite mounted phased array antenna comprises 320 antenna elements and associated amplifiers and phase shifters. Different phased array antennas will have different numbers of antenna elements depending on their design and intended purpose. The electronic steering of the antenna is achieved by phase shifting individual antenna components via phase shifters 624 and 627 as is known in the art.

A pulse generator 620 generates a RF signal that is sent to the radar transmit and receive module 621. The radar signal is sent to the RF divider 622 and that divides the RF signal and sends it to multiple antenna modules 670. One antenna module 670 is shown in FIG. 6, but there can be multiple antenna modules. A RF combiner 629 receives the combined signals from the multiple antenna modules 670 and sends the received RF signal to the radar transmit and receive module 630. The data is stored in memory 631. Memory 631 may be the same or separate from memory 108. The pulse generator 620, radar transmitter 621, radar receiver 630, RF divider 622, and RF combiner 629 can be located in either the satellite body 110 or on the satellite wing 160. The additional arrow extending from the RF divider 622 in FIG. 6 indicates one or more additional RF outputs from the RF divider 622 to one or more additional antenna modules, and the additional arrow pointing to RF combiner 629 indicates one or more additional RF inputs going into RF combiner 629 from one or more additional antenna modules.

The methods and systems described here refer to the steering of a single antenna or a single aperture. However, they may be readily extended to systems comprising multiple antennas or multiple apertures.

The antenna modules 670 multiplied for the number of antenna modules, collectively form the image acquisition apparatus of the satellite, as is known to those skilled in the art. They may perform functions other than the acquisition of image data.

In a typical satellite an antenna may comprise a phased array antenna as noted above. A phased array antenna with antenna elements spatially distributed over two dimensions perpendicular to the radar-range dimension may allow two-dimensional beam steering in azimuth and elevation.

The available electronic steering of a phased array antenna may be limited by the physical antenna in range and spacing of phase centers in azimuth resulting in reduced gain and increased grating lobes if too much steering is attempted. The limits on available angle ranges will vary from one physical apparatus to another but typical limits might be set at ±25° in elevation and ±2° in azimuth.

The payload 660 receives power from the power distribution system 102 and instructions from computing system 103. Data from the payload 660 such as received radar signals also flows back to the computing system 103 and can be stored in memory 108. The data may be processed by the computing system 103, for example to generate images as described elsewhere here, which may then be output to the communication system 104 for onward transmission. In the system illustrated in FIG. 6, raw data can also be output by the computing system 103 to the communication system 104, which further sends it out for processing by a remote computing system. In FIG. 6, a SAR processor 133 may be located at a ground station, for example, or in another processing location. The computing system 103 may send operating instructions to other components located in the payload 660, such as the radar transmitter 621, the radar receiver 630 and/or the phase shifters 624 and 627, as will be familiar to those skilled in the art. Raw SAR data can be stored in the satellite in memory 108 or 631. Memory 108 and 631 could be the same or different memory modules or could also be part of computing system 103.

Raw SAR data stored in buffer 135 and communicated to a ground station 600 or a remote SAR process 133. In an example, 30 seconds of image data can be stored at full resolution (bandwidth). More can be stored at lower resolution (e.g., 60 seconds at half resolution). In an example, a micro satellite has a 150 MBs download link. At this data rate it takes about 3 minutes to download the 30 seconds of full resolution imagery data. During operation, around 5000 pulses per second may be transmitted. This means that 27 pulses might be in the air at any given time. A burst typically comprises 500-1000 pulses and takes 2-3 seconds.

The communication system 104 may communicate with earth stations or other satellites using radio frequency communication, light, e.g., laser communication, or any other form of communication as is known in the art.

A satellite, for example satellite 100 of FIG. 1, is generally provided with a propulsion system 190 for maneuvering the satellite with a generated thrust. The propulsion system 190 is shown in FIG. 1 to be mounted on the body 110 on the surface opposite the solar panels 150.

As shown in FIG. 1, the propulsion system 190 comprises a plurality of thrusters 105 that produce thrust for maneuvering the satellite 100 when required.

The thrusters 105 are generally operated to maintain the satellite in a particular orbit. For example, the thrusters may be used to propel the satellite in a particular direction with respect to the surface of the earth.

Referring back to FIG. 6, the ADCS 131 is usually located in the satellite body 110 and is used to control the orientation of the satellite. ADCS may be implemented in a number of ways. The ADCS 131 is shown in the figures to comprise a set of reaction wheels, one of which is indicated schematically in FIG. 1. The reaction wheels are usually, but not necessarily, located in the satellite body 110. FIG. 7 is a partial perspective view of a satellite and shows a set of three reaction wheels 41, 42, 43 located in the satellite body 110. Reaction wheels are sometimes also known as momentum wheels.

In the satellite described here, the ADCS may be used to mechanically steer the satellite to maintain a target area 200 on Earth within the radar aperture, in other words in sight of the satellite, for a longer period than the target would be visible without mechanical steering as the satellite travels in its orbit. In principle the range of angles for mechanical steering is limited only by the horizons in each direction, but the greater the angle, the larger is the distance to the target area and hence the weaker is the returned signal.

Reaction wheels 41, 42, 43 function by using an electric motor to spin a wheel inside the spacecraft body 110. By conservation of angular moment, spinning the wheel in one direction causes the spacecraft to rotate in the opposite direction. Using reaction wheels is a well-known way of orienting spacecraft such as satellites.

In an example, three reaction wheels are positioned inside a spacecraft body, one for orienting the satellite in each axis. Thus reaction wheels 41, 42, 43 are shown to have orthogonal axes.

In another example, four or more reaction wheels may be used in order to have better control over various aspects of the satellites dynamics, such as slew rate (how fast the satellite can turn) and fine positioning control, particular for satellites with higher moments of inertia.

Various classes of satellites are currently in orbit around the earth, generally defined by ranges of weights, although the boundaries between the classes are somewhat fluid and arbitrary:
Cube satellites: 1 kg-10 kg
Micro satellites: 50 kg- to 250 kg
Small satellites: 500 kg-800 kg
Regular satellites: 800-1200 kg.
Large satellites: >1200 kg.

Reaction wheels are rated in terms of their “momentum capacity”, which has units of nms (newton-metre-seconds). The slew rate is related to the speed of the wheel and the inertia of the satellite system. A satellite having a particularly low mass has a much lower moment of inertia than traditional larger SAR satellites. A suitably low mass may be under 1000 kg, for example under 500 kg, under 250 kg, between 50 kg and 250 kg, or under 100 kg.

Very small cube satellites do not at present have the capability to carry a current SAR payload. Heavier satellites are generally less agile due to their higher inertia. Embodiments of the satellite and operating methods described here have been successfully implemented in a micro satellite.

Embodiments of the invention are particularly applicable to the class of satellites known as micro satellites.

Some of the methods to be described further here benefit from reaction wheels within a particular rating range. A suitable range for example for micro satellites can be 0.5 to 2.5 nms. Reaction wheels with a rating of 1 nms have been successfully trialed. This has enabled slew in the range of 1°/second, which is sufficient to track a spot on the ground and to implement any of the methods described here without consuming too much power. Thus in any of the satellites described here, the ADCS may be configured to slew the satellite in the azimuth direction at up to 1 degree/second using mechanical steering.

Larger satellites are known to use reaction wheels of the order of 10 nms, but they are not currently able to achieve sufficient slew rates due to the large mass of the satellites and the resulting high rotational inertia, and they also consume much more power than the smaller reaction wheels.

In an example, the satellite is orbiting Earth in a low-earth orbit. A low-earth orbit can be from 160 km to 1000 km above the surface of the Earth. Examples of Earth-observation satellites based on SAR can have orbits of between 450 km and 650 km above the Earth. In an example according to the current invention, a satellite has an orbit that is 550 km above the Earth's surface. At an orbit of 550 km above the Earth, for example, the satellite is effectively traversing the ground at about 7.5 km/s, or 27,000 km/h. Most satellites in this this orbit will traverse the Earth at a speed that is in the range of 7-8 km/s.

In some embodiments, a satellite such as a micro satellite can slew at a speed necessary to maintain pointing at a spot on Earth for about 10 minutes from horizon to horizon. However, at the extremes of this range the distance to the spot or target being imaged may be too far to get a good SAR image, so there is a smaller practical dwell time.

As noted elsewhere here, embodiments of the invention are not limited to changing the orientation of the whole satellite, which is convenient in the case of the small, lightweight, agile satellites described above. For example, in some embodiments, the mechanical steering may be achieved by changing the orientation of an antenna with respect to a satellite on which it is carried.

In the foregoing only one SAR beam has been considered. However it will be appreciated that the methods and systems described here may be extended to the use of multiple SAR beams. For example a platform might carry apparatus for multiple SARs, each of which may be operated according to any of the methods described here.

It will be appreciated from the foregoing that all of the methods described here benefit from the use of an agile micro satellite. A suitably sized micro satellite can rotate to observe a target for an extended period of time. This provides them the unprecedented capability of achieving many frames of imagery at the same resolution as the range resolution over a period of time.

There is described in the foregoing a satellite suitable for implementing any of the methods of operation described here. For a satellite or other platform already in orbit, the methods described here may be implemented by suitably controlling the satellite, for example from the ground using a suitable computing system, for example ground station computing system 600. In other words a SAR may be operated from the ground and some of the methods described here may be implemented in software. Therefore in an aspect the invention may provide a computer readable medium comprising instructions which, when implemented by a processor in a computing system, cause the computing system to operate a SAR according to any of the methods described here.

The acquisition of SAR image data as described here may have many different practical applications. An end-to-end process may begin with a request to image a particular area, for example it may be requested by a customer or identified as interesting by an algorithm. Depending on the size of the area and a desired resolution, a suitable number of subswaths may be selected. Based on the number of subswaths, a sequence of bursts in azimuth may then be devised to best acquire the image data. Before starting the acquisition, the satellite may be rotated to an initial position, such as position (a) in FIG. 3. From the initial position the image data may be collected by mechanically steering the beam opposite to the flight direction and electronically steering the beam according to the sequence of bursts.

In an example, a request is received from a customer to image a relatively large area that is 100 km×100 km. Using the prior art TOPS (Terrain Observation with Progressive Scans) mode where electronic steering is used in both azimuth and elevation, the 100 km wide swath could for example be imaged using three subswaths to achieve a resolution of 15 metres. Using TOPS mode, the acquisition would take about 15 seconds as the satellite travels 100 km along its orbital track over the area of interest.

In an example, a small agile satellite of approximately 150 kg can image the 100 km×100 km area at a resolution of 5 m using the apparatus, methods and techniques described herein by combining electronic steering with the mechanical steering capabilities of the satellite in order to slow down the effective ground speed of the SAR beam. In an example, a resolution of 5 m can be achieved over the 100 km×100 km area by dividing it into four subswaths and with an extended acquisition time of about 42 seconds. This represents a three times improvement in resolution compared to the example TOPS case for imaging of this size of area.

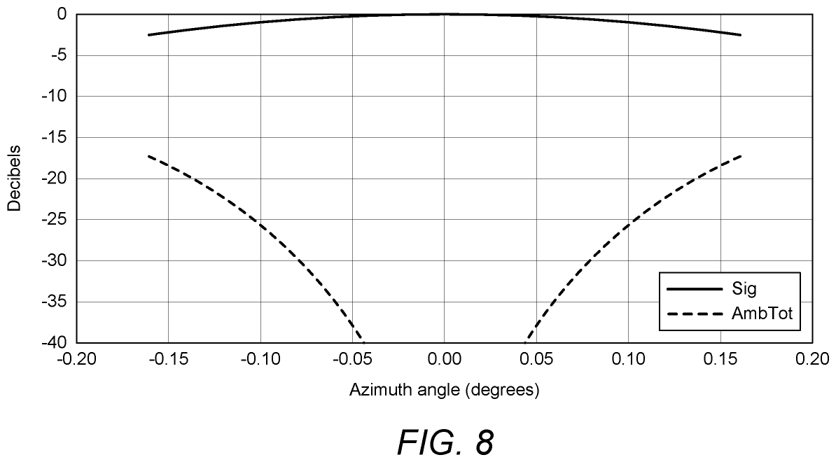

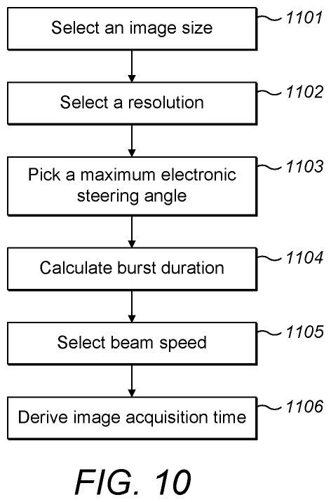

FIG. 8 shows the performance of this 100 km×100 km example by plotting the signal and the potential performance loss due to ambiguities in the azimuth direction. The vertical axis is given in decibels (dB), and the horizontal axis is the azimuth angle in degrees. In general, minimal degradation of the signal is desired along with a low azimuth ambiguity value. It can be seen from FIG. 8 that the signal at the edges of each burst is degraded by no more than approximately −2.5 dB. The total ambiguity trace (AmbTot) shows at worse a value of approximately −17 dB at the very edges of the burst. This is considered to be in an acceptable range of degradation at the edges. A threshold value for azimuth ambiguity can be fed into the algorithm for determining possible imaging areas and resolutions, as described below with reference to FIG. 10.

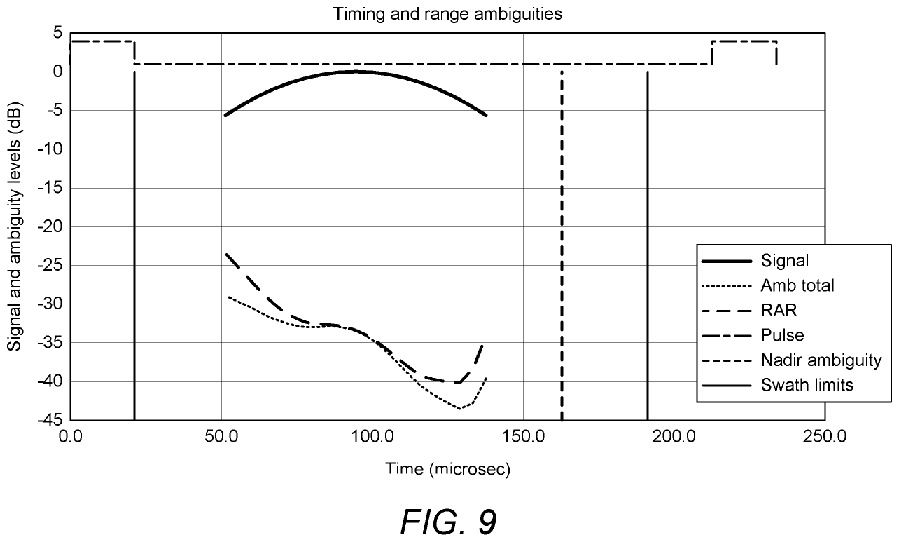

FIG. 9 shows a plot of performance losses due to range ambiguities (Amb Total) and the Range Ambiguities Ratios (RAR) against time for a single burst. The traces shown in both FIG. 8 and FIG. 9 are obtained from a mathematical model that computes the azimuth ambiguity values and the range ambiguity values by numerical integration of appropriate portions of the antenna patterns. In this example of imaging a 100 km×100 km area with a resolution of 5 m, the highest value for the total ambiguity trace (Amb Total) is approximately −28 dB, leading to a worse case RAR of approximately −24 dB. This is considered to be within an acceptable range. As with the azimuth ambiguity value, a threshold can be used to determine the possible resolutions and imaged areas achievable using the high resolution wide swath technique.

In another example, the high resolution wide swath technique can be used to image a smaller area of 60 km×60 km at an even finer 3 m resolution by using two subswaths and mechanical steering superimposed on top of the electronic steering over an acquisition period of 35 seconds. In an example, even finer resolutions, such as 1 m resolution or less are possible.

FIG. 10 shows an example of an algorithm that can be used to determine the parameters to be used for a particular acquisition. In a first step 1101, an image size is chosen, for example 100 km×100 km, or 60 km×60 km. In a second step 1102, a resolution is chosen, for example 5 m. In step 1103, a maximum electronic steering angle in azimuth is chosen, and this determines the patch size on the ground. The maximum electronic steering angle is constrained by the antenna design, more specifically by how far the antenna can scan before grating lobes become an issue due to the antenna element spacing in azimuth.

The resolution then drives the burst duration, which is calculated in step 1104 according to Equation 9:

$$τ = λ R / ( 2 {V}_{s} {ρ}_{az} ) \qquad ( Equation 9 )$$

In Equation 9, τ is the burst duration, λ is the wavelength, R is the slant range, Vₛ is the satellite speed, and ρ_{az} is the azimuth resolution. The beam speed, V_{g}, is selected in step 1105 such that the beam slides over the patch in the required time τ. The image acquisition time is then derived in step 1106 from the along-track image size. According to this method, the parameters required for tasking a satellite to acquire an image can be calculated. Any image size and any resolution can be done, subject to acquisition time constraints and squint angle limits.

Any of the computing systems described here may be combined in a single computing system with multiple functions. Similarly the functions of any of the computing systems described herein may be distributed across multiple computing systems.

Some operations of the methods described herein may be performed by software in machine readable form e.g., in the form of a computer program comprising computer program code. Thus some aspects of the invention provide a computer readable medium which when implemented in a computing system cause the system to perform some or all of the operations of any of the methods described herein. The computer readable medium may be in transitory or tangible (or non-transitory) form such as storage media include disks, thumb drives, memory cards etc. The software can be suitable for execution on a parallel processor or a serial processor such that the method steps may be carried out in any suitable order, or simultaneously.

The embodiments described above are largely automated. In some examples a user or operator of the system may manually instruct some steps of the method to be carried out.

In the described embodiments of the invention the system may be implemented as any form of a computing and/or electronic system as noted elsewhere herein. For example, the ground station may comprise such a computing and/or electronic system. Such a system may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

The term “computing system” is used herein to refer to any device with processing capability such that it can execute instructions. Those skilled in the art will realise that such processing capabilities may be incorporated into many different devices and therefore the term “computing system” includes PCs, servers, smart mobile telephones, personal digital assistants and many other devices.

It will be understood that the benefits and advantages described above may relate to one embodiment or may relate to several embodiments. The embodiments are not limited to those that solve any or all of the stated problems or those that have any or all of the stated benefits and advantages.

Any reference to “an” item or “piece” refers to one or more of those items unless otherwise stated. The term “comprising” is used herein to mean including the method steps or elements identified, but that such steps or elements do not comprise an exclusive list and a method or apparatus may contain additional steps or elements.

Further, to the extent that the term “includes” is used in either the detailed description or the claims, such term is intended to be inclusive in a manner similar to the term “comprising” as “comprising” is interpreted when employed as a transitional word in a claim.

The figures illustrate exemplary methods. While the methods are shown and described as being a series of acts that are performed in a particular sequence, it is to be understood and appreciated that the methods are not limited by the order of the sequence. For example, some acts can occur in a different order than what is described herein. In addition, an act can occur concurrently with another act. Further, in some instances, not all acts may be required to implement a method described herein.

The order of the steps of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples.

It will be understood that the above description of a preferred embodiment is given by way of example only and that various modifications may be made by those skilled in the art. What has been described above includes examples of one or more embodiments. It is, of course, not possible to describe every conceivable modification and alteration of the above devices or methods for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims.

What is claimed is:

1. A method of operating a Synthetic Aperture Radar (SAR) to acquire image data of a swath comprising one or more subswaths, wherein the SAR is carried on a platform moving along a flight direction and a radiated beam is directed towards the swath, the method comprising:
electronically steering the beam in azimuth direction along one subswath for each burst; and
mechanically steering the beam in a direction opposite to the flight direction during each burst.

2. The method of claim 1, wherein mechanically steering the beam is performed by rotating the SAR with respect to the platform, moving or slewing the platform including the SAR, or both.

3. The method of claim 1, wherein mechanically steering the beam reduces an effective ground speed of the beam on Earth.

4. The method of claim 1, wherein a steering angle rate for mechanically steering the beam is lower than a steering angle rate for electronically steering the beam, optionally at least by factor 3.

5. The method of claim 1, wherein a steering angle range for mechanically steering the beam is higher than a steering angle range for electronically steering the beam, optionally at least by factor 30.

6. The method of claim 1, further comprising:
electronically steering the beam in elevation between two bursts.

7. The method of claim 1, further comprising:
successively steering the beam in elevation during one acquisition cycle comprising a plurality of bursts, wherein each burst illuminates a different subswath.

8. The method of claim 7, further comprising:
performing two or more acquisition cycles, wherein each first burst of each acquisition cycle illuminates a same subswath.

9. The method of claim 7, further comprising
mechanically steering the beam continuously during the one or more acquisition cycles in the direction opposite to the flight direction.

10. The method of claim 1, wherein parameters to be used for image acquisition are determined by:
a. selecting an image size;
b. selecting a resolution;
c. picking a maximum electronic steering angle;
d. calculating a burst duration;
e. selecting a beam speed; and
f. deriving an image acquisition time.

11. A satellite for operating in an orbit around the Earth comprising a Synthetic Aperture Radar (SAR) to acquire image data of a swath comprising one or more subswaths, wherein the satellite is configured to move along a flight direction and the SAR is configured to direct a radiated beam towards the swath, wherein the SAR is further configured to
Electronically steer the beam in azimuth direction along one of the one or more subswaths for each burst; and
mechanically steer the beam in a direction opposite to the flight direction during each burst.

12. The satellite of claim 11, wherein the satellite comprises an Attitude Determination Control System (ADCS) including one or more reaction wheels configured to control the mechanical steering of the beam by rotating the satellite including the SAR.

13. The satellite of claim 11, wherein the satellite is configured to mechanically steer the beam by slewing in the azimuth direction at up to 1°/second.

14. The satellite of claim 11, wherein the satellite has a total mass of less than 1000 kg.

15. The satellite of claim 11, wherein the SAR comprises a small single aperture radar, a phased array, or both allowing electronic beam steering in two dimensions.

16. (canceled)

17. A ground station that:
controls a satellite operating in an orbit around the Earth and comprising a Synthetic Aperture Radar (SAR) to acquire image data of a swath comprising one or more subswaths, the satellite being configured to move along a flight direction and the SAR and to direct a radiated beam towards the swath; and
causes the satellite to (a) electronically steer the beam in azimuth direction along one subswath for each burst and (b mechanically steer the beam in a direction opposite to the flight direction during each burst.
